(19) United States
(12) Patent Application Publication
(10) Pub. No.: US 2022/0063092 A1
(43) Pub. Date: Mar. 3, 2022

(54) CONTROL DEVICE, CONTROL METHOD, AND PROGRAM

(71) Applicant: SONY GROUP CORPORATION, TOKYO (JP)

(72) Inventors: RYO TERASAWA, TOKYO (JP); YASUHIRO MATSUDA, KANAGAWA (JP); KATSUFUMI SUGIMOTO, TOKYO (JP)

(21) Appl. No.: 17/309,830

(22) PCT Filed: Nov. 18, 2019
(86) PCT No.: PCT/JP2019/044987

§ 371 Date: Jun. 22, 2021

(30) Foreign Application Priority Data
Jan. 4, 2019 (JP) 2019-000180

(51) Int. Cl. B25J 9/16; G05B 19/4103

(52) U.S. Cl. CPC B25J 9/1633; G05B 2219/39001; G05B 2219/34083; G05B 19/4103

(57) ABSTRACT

A control device provided with an interpolated attitude deriving section for deriving an interpolated attitude at a via-point of a machine element that moves in a trajectory reaching an end point from a starting point via the via-point, an optimum attitude deriving section for deriving an optimum attitude at the via-point of the machine element, and an attitude deriving section that derives an attitude that the machine element is controlled to have at the via-point on the basis of the interpolated attitude and the optimum attitude.

### TECHNICAL FIELD

The present disclosure relates to a control device, a control method, and a program.

### BACKGROUND ART

Generally, as for a manipulator or the like provided in a robot device (hereinafter, also referred to as a machine element), the operation is controlled on the basis of a motion trajectory instructing a position and an attitude of the manipulator or the like.

In order to appropriately control the operation of such a machine element, it is important to appropriately determine the position and the attitude of the machine element in the motion trajectory connecting the starting point and the end point of the movement. However, it is not preferable to search for the position and the attitude of the machine element at the same time when planning the motion trajectory because the degree of freedom of search is high (six freedom degrees in total) and the search takes time.

Therefore, first, it is considered that a via-point is determined on the motion trajectory, and the position of the machine element (three freedom degrees) at the via-point is searched for, and then the attitude of the machine element (three freedom degrees) is searched for on the basis of the position of the machine element having been searched out.

For example, PTL 1 below describes a method in which an attitude data table in which position data on the trajectory and attitude data of a manipulator are associated with each other is stored in advance, and the attitude of the manipulator is determined on the basis of the position data of the manipulator.

### CITATION LIST

### Patent Literature

[PTL 1]

Japanese Patent Laid-open No. Hei 10-315169

### SUMMARY

### Technical Problem

However, in the case where an attitude of a machine element is determined on the basis of a position of the machine element at a via-point, the determined attitude of the machine element may not be an appropriate attitude in consideration of mechanistic features of the machine element. Therefore, there has been a demand for a control device, a control method, and a program capable of more appropriately deriving the attitude of the machine element at the via-point existing between a starting point and an end point of a motion trajectory.

### Solution to Problem

According to the present disclosure, provided is a control device including an interpolated attitude deriving section that derives an interpolated attitude at a via-point of a machine element moving in a trajectory that reaches the end point via the via-point from a starting point, an optimum attitude deriving section that derives the optimum attitude of the machine element at the via-point, an attitude deriving section that derives an attitude that the machine element is controlled to have at the via-point on the basis of the interpolated attitude and the optimum attitude.

Further, according to the present disclosure, provided is a control method performed by a calculation device, which includes derivation of an interpolated attitude at a via-point of a machine element moving in a trajectory that reaches the end point via the via-point from the starting point, derivation of the optimum attitude of the machine element at the via-point, and derivation of an attitude that the machine element is controlled to have at the via-point, on the basis of the interpolated attitude and the optimum attitude.

In addition, according to the present disclosure, provided is a program that causes a computer to function as an interpolated attitude deriving section that derives an interpolated attitude at a via-point of a machine element moving in a trajectory that reaches the end point via the via-point from the starting point, an optimum attitude deriving section for deriving the optimum attitude of the machine element at the via-point, and an attitude deriving section that derives an attitude that the machine element is controlled to have at the via-point on the basis of the interpolated attitude and the optimum attitude.

### BRIEF DESCRIPTION OF DRAWINGS

FIG. 1A is a schematic view illustrating an example of a position and an attitude of a machine element at a starting point.

FIG. 1B is a schematic view illustrating an example of the position and the attitude of the machine element at the end point.

FIG. 2A is a schematic view illustrating an example of the position and the attitude of the machine element at a via-point.

FIG. 2B is a schematic diagram illustrating another example of the position and the attitude of the machine element at the via-point.

FIG. 3 is a block diagram illustrating a functional configuration of a control device according to an embodiment of the present disclosure.

FIG. 4 is a flowchart illustrating an operation example of the control device when deriving the attitude of the machine element.

FIG. 5 is an explanatory diagram illustrating spherical linear interpolation by quaternions.

FIG. 6 is an explanatory diagram illustrating an Euclidean distance between the starting point and the via-point and the Euclidean distance between the via-point and the end point.

FIG. 7 is an explanatory diagram illustrating derivation of the interpolated attitude of the machine element at the via-point, using the quaternion spherical linear correction.

FIG. 8 is an explanatory diagram illustrating a quadratic Bezier curve passing through a starting point, a via-point, and an end point.

FIG. 9 is an explanatory diagram for illustrating derivation of the optimum attitude of the machine element at the via-point in consideration of the mechanism of the machine element.

FIG. 10A is a graph illustrating an example of a function that controls an internal division ratio between the interpolated attitude and the optimum attitude.

FIG. 10B is a graph illustrating another example of the function that controls the internal division ratio between the interpolated attitude and the optimum attitude.

FIG. 10C is a graph illustrating another example of the function that controls the internal division ratio between the interpolated attitude and the optimum attitude.

FIG. 11 is a block diagram illustrating an example of a hardware configuration of a control device according to an embodiment of the present disclosure.

### DESCRIPTION OF EMBODIMENT

A preferred embodiment of the present disclosure will be described in detail below with reference to the accompanying drawings. Incidentally, in the present specification and the drawings, components having substantially the same functional configuration are denoted by the same reference numerals to omit duplicate description.

Note that the descriptions will be given in the following order.
1. Outline of Technology Related to Present Disclosure
2. Configuration Example of Control Device
3. Operation Example of Control Device
4. Hardware Configuration Example
5. Summary

### <1. Outline of Technology Related to Present Disclosure>

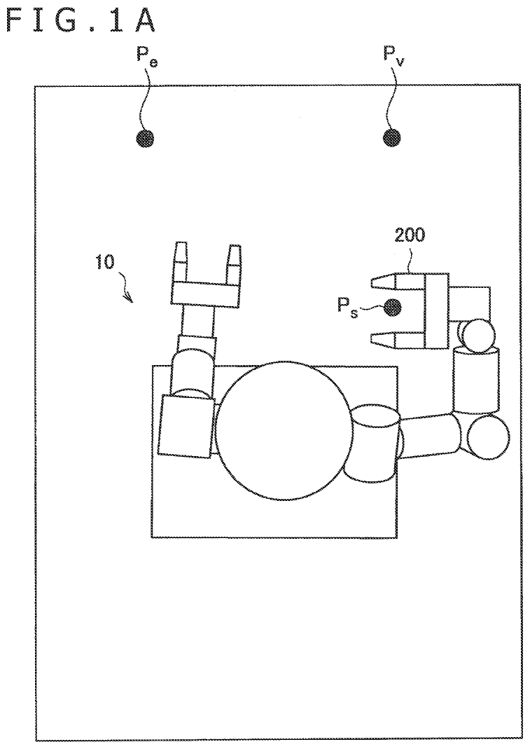

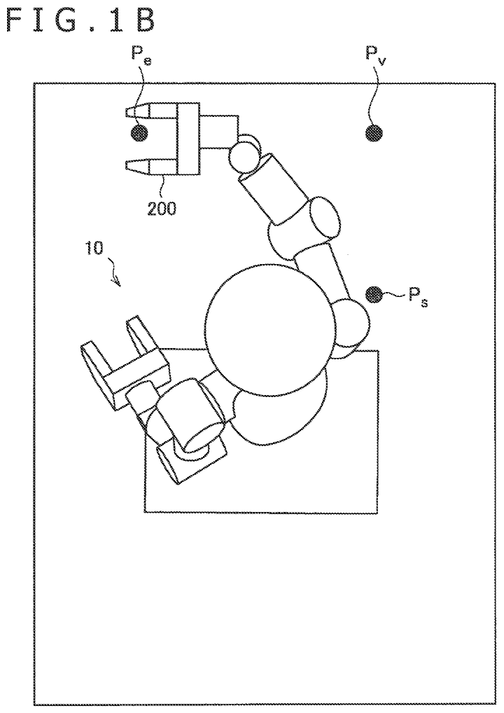

First, the outline of the technology according to the present disclosure will be described with reference to FIGS. 1A to 2B.

For example, a case is considered where a machine element 200 such as a robot arm of a robot device 10 is moved from a starting point Pₛ to an end point Pₑ via a via-point Pᵥ. Specifically, a case where the robot device 10 is operated from a position and an attitude of the machine element 200 at the starting point Pₛ illustrated in FIG. 1A to the position and the attitude of the machine element 200 at the end point Pₑ illustrated in FIG. 1B will be considered. Note that for the sake of simplicity of the explanation, as illustrated in FIGS. 1A and 1B, the attitudes of the machine element 200 at the starting point Pₛ and the end point Pₑ are the same.

At this time, the attitude of the machine element 200 at the via-point Pᵥ can be derived from, for example, the attitudes of the machine element 200 at the starting point Pₛ and the end point Pₑ. Specifically, the attitude of the machine element 200 at the via-point Pᵥ can be derived by adding the attitudes of the machine element 200 at the starting point Pₛ and the end point Pₑ to each other. For example, the attitude of the machine element 200 at the starting point Pₛ illustrated in FIG. 1A is the same as the attitude of the machine element 200 at the end point Pₑ illustrated in FIG. 1B. Therefore, the attitude of the machine element 200 at the via-point Pᵥ can be derived as the same as the attitude of the machine element 200 at the starting point Pₛ and the end point Pₑ.

However, in the case where the attitude of the machine element 200 at the via-point Pᵥ is derived by such a method, a solution in which the attitude of the machine element 200 is appropriate cannot exist depending on the position of the via-point Pᵥ, as illustrated in FIG. 2A. Further, depending on the position of the via-point Pᵥ, the attitude of the machine element 200 may become unnatural or inefficient.

On the other hand, the attitude of the machine element 200 at the via-point Pᵥ can be derived from the mechanical features of the machine element 200, for example, without considering the attitudes of the machine element 200 at the starting point Pₛ and the end point Pₑ. Specifically, the attitude of the machine element 200 at the via-point Pᵥ can be derived such that the torque applied to each part of the machine element 200 at the via-point Pᵥ is small, or the manipulability of the machine element 200 is high.

However, in the case where the attitude of the machine element 200 at the via-point Pᵥ is derived by such a method, the attitude of the machine element 200 may be significantly changed from the attitude at the starting point Pₛ or the end point Pₑ as illustrated in FIG. 2B, and the operating efficiency of the machine element 200 may decrease.

Therefore, it is desirable that the attitude of the machine element 200 at the via-point Pᵥ is derived in consideration of a plurality of attitudes derived by different methods. The technique according to the present disclosure has been considered in view of the above circumstances. Specifically, the technique according to the present disclosure derives the attitude of the machine element 200 at the via-point Pᵥ on the basis of the interpolated attitude and the optimum attitude.

Here, the interpolated attitude is an attitude derived by interpolation between the attitude of the machine element 200 at the starting point Pₛ and the attitude of the machine element 200 at the end point Pₑ. On the other hand, the optimum attitude is an attitude derived on the basis of the mechanistic features of the machine element 200. According to the technique related to the present disclosure, the attitude of the machine element 200 at the via-point Pᵥ can be more appropriately controlled by deriving the attitude of the machine element 200, using the interpolated attitude and the optimum attitude.

Hereinafter, the control device that realizes the technique according to the present disclosure outlined above will be described in detail.

### <2. Configuration Example of Control Device>

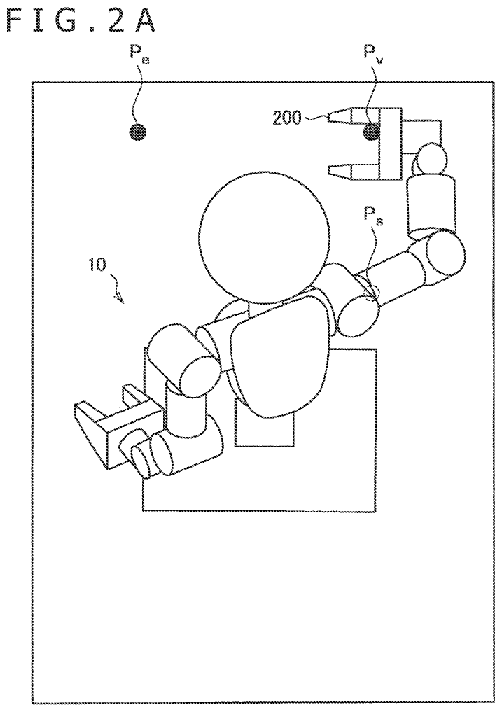

Next, a specific configuration example of a control device 100 according to an embodiment of the present disclosure will be described with reference to FIG. 3. FIG. 3 is a block diagram illustrating a functional configuration of the control device 100 according to the present embodiment.

As illustrated in FIG. 3, the control device 100 includes a recognizing section 110, a trajectory generating section 120, an interpolated attitude deriving section 130, an optimum attitude deriving section 140, an attitude deriving section 150, and a control section 160.

For example, the control device 100 controls the position and the attitude of the machine element 200 by controlling a drive unit 220 of the machine element 200 on the basis of the information acquired by a sensor unit 210. The control device 100 may be provided inside the robot device 10 including the machine element 200, or may be provided outside the robot device 10 including the machine element 200.

Here, the machine element 200 represents a member whose position and attitude can be controlled by a mechanical mechanism among the members provided in the robot device 10. For example, the machine element 200 may be a robot arm of the robot device 10 or an end effector at the tip of the robot arm, or may be a leg of the robot device 10 or a ground contact portion at the tip of the leg.

The sensor unit 210 includes a sensor for acquiring information regarding the environment around the robot device 10 and a sensor for acquiring information regarding the robot device 10 itself. For example, the sensor unit 210 may include various cameras such as an RGB camera, a grayscale camera, a stereo camera, a depth camera, an infrared camera, and a ToF (Time of Flight) camera as sensors for acquiring environmental information around the robot device 10. The sensor unit 210 may include various ranging sensors such as a LIDAR (Laser Imaging Detection and Ringing) sensor or a RADAR (Radio Detection and Ringing) sensor. The sensor unit 210 may include an environment sensor such as a microphone, an illuminance meter, a thermometer, or a hygrometer. Further, the sensor unit 210 may include, for example, an encoder, a voltmeter, an ammeter, a strain gauge, a pressure gauge, an IMU (Inertial Measurement Unit), or the like as a sensor for acquiring the own machine information of the robot device 10.

However, it goes without saying that the sensor unit 210 may include a known sensor other than the above-mentioned sensors as long as the sensor unit 210 can acquire the environmental information around the robot device 10 or the own machine information of the robot device 10.

The recognizing section 110 recognizes the environmental state around the robot device 10 or the own machine state of the robot device 10 on the basis of the information acquired by the sensor unit 210. Specifically, the recognizing section 110 may recognize the environment state around the robot device 10 by performing obstacle recognition, shape recognition, object recognition, marker recognition, character recognition, white line recognition, lane recognition, or voice recognition based on the environmental information acquired by the sensor unit 210. Further, the recognizing section 110 may recognize the own machine state of the robot device 10 by performing position recognition, motion state (speed, acceleration, jerk, etc.) recognition, or the body state (remaining power supply, temperature, joint angle, etc.) recognition based on the own machine information acquired by the sensor unit 210.

Any of the above recognition operations by the recognizing section 110 can be performed by using a known recognition technique. The recognition by the recognizing section 110 may be performed on the basis of a predetermined rule, or may be performed on the basis of a machine learning algorithm, for example.

The trajectory generating section 120 generates a trajectory for operating the machine element 200 of the robot device 10 on the basis of a recognition result by the recognizing section 110. Specifically, first, the trajectory generating section 120 determines the starting point Pₛ and end point Pₑ for operating the machine element 200 on the basis of the environmental state around the robot device 10 and the own machine state of the robot device 10 recognized by the recognizing section 110. Next, the trajectory generating section 120 generates a trajectory of the machine element 200 connecting the determined starting point Pₛ and end point Pₑ, and determines the position of the machine element 200 on the trajectory and the attitude of the machine element 200 at the position. The control device 100 can move the machine element 200 along the generated trajectory by controlling the drive of the drive unit 220 on the basis of the generated trajectory.

Further, the trajectory generating section 120 sets the via-point Pᵥ through which the trajectory connecting the starting point Pₛ to the end point Pₑ passes and determines the position of the machine element 200 at the via-point Pᵥ when generating the trajectory. The trajectory generating section 120 may set the via-point Pᵥ as an intermediate point for facilitating the search for the trajectory, or may set the via-point Pᵥ for avoiding obstacles, or may set the via-point Pᵥ in accordance with the instruction from a user. Further, the trajectory generating section 120 may set a plurality of via-points Pᵥ on the trajectory. Incidentally, in the case where the via-point Pᵥ is set by the trajectory generating section 120, the trajectory generating section 120 may set the position of the machine element 200 at the via-point Pᵥ by using a known search algorithm.

Here, in the control device 100 according to the present embodiment, the attitude of the machine element 200 at the via-point Pᵥ is derived by the attitude deriving section 150 to be described later. Specifically, the attitude of the machine element 200 at the via-point Pᵥ is derived on the basis of the interpolated attitude derived by the interpolated attitude deriving section 130 and the optimum attitude derived by the optimum attitude deriving section 140.

According to this, when the control device 100 searches for the route from the starting point Pₛ to the end point Pₑ, it is sufficient if only the position of the machine element 200 is searched for instead of both the position and the attitude of the machine element 200 at the via-point Pᵥ. Accordingly, when setting the via-point Pᵥ using the search algorithm, the control device 100 can reduce the search load and time, because it is sufficient if the search is performed with three freedom degrees of the position of the machine element 200 instead of six freedom degrees of the position and the attitude of the machine element 200.

The interpolated attitude deriving section 130 derives the interpolated attitude at the via-point Pᵥ on the basis of the attitude of the machine element 200 at the starting point Pₛ and the attitude of the machine element 200 at the end point Pₑ.

Specifically, the interpolated attitude deriving section 130 may derive the interpolated attitude at the via-point Pᵥ by linear interpolation of the attitude of the machine element 200 at the starting point Pₛ and the attitude of the machine element 200 at the end point Pₑ. For example, the interpolated attitude deriving section 130 may derive the interpolated attitude at the via-point Pᵥ by linear interpolation between the attitude at the starting point Pₛ and the attitude at the end point Pₑ by using the ratio of the distance from the starting point Pₛ to the via-point Pᵥ to the distance from the end point Pₑ to the via-point Pᵥ. That is, the interpolated attitude deriving section 130 may derive one attitude on the way of the attitude transition of the machine element 200 from the starting point Pₛ to the end point Pₑ as the interpolated attitude.

The interpolated attitude at the via-point Pᵥ is used by the attitude deriving section 150, which will be described later, to derive the attitude that the machine element 200 is actually controlled to have at the via-point Pᵥ. The control device 100 uses the interpolated attitude to derive the attitude that the machine element 200 is actually controlled to have, so that the attitude of the machine element 200 at the via-point Pᵥ can be prevented from causing a large change from the attitude of the machine element 200 at the starting point Pₛ or the end point Pₑ.

The optimum attitude deriving section 140 derives the optimum attitude at the via-point Pᵥ on the basis of the mechanistic features of the machine element 200. Specifically, the optimum attitude deriving section 140 may derive the optimum attitude at the via-point Pᵥ on the basis of at least one of the manipulability of the machine element 200, the torques applied to the machine element 200, or the singular points of the machine element 200. For example, the optimum attitude deriving section 140 may derive the optimum attitude such that the manipulability of the machine element 200 is higher, or may derive the optimum attitude such that the torques applied to the machine element 200 are smaller, or may derive the optimum attitude so as to avoid the singular points of the machine element 200. That is, the optimum attitude deriving section 140 may derive the attitude in which the mechanism of the machine element 200 is optimal at the via-point Pᵥ as the optimum attitude.

Alternatively, the optimum attitude deriving section 140 may derive the optimum attitude at the via-point Pᵥ such that the tangential direction of the trajectory passing through the via-point Pᵥ and the approaching direction of the machine element 200 at the via-point Pᵥ substantially coincide with each other.

The interpolated attitude at the via-point Pᵥ is used by the attitude deriving section 150, which will be described later, to derive the attitude that the machine element 200 is actually controlled to have at the via-point Pᵥ. The control device 100 can allow the machine element 200 at the via-point Pᵥ to have an attitude in which the machine element 200 has a smaller load by deriving the attitude that the machine element 200 is actually controlled to have, by using the optimum attitude. Further, the control device 100 derives the attitude that the machine element 200 is actually controlled to have, by using the optimum attitude, so that the attitude of the machine element 200 at the via-point Pᵥ can be an attitude making the operation of the machine element 200 more appropriate.

The attitude deriving section 150 derives the attitude that the machine element 200 is actually controlled to have at the via-point Pᵥ on the basis of the interpolated attitude and the optimum attitude. Specifically, the attitude deriving section 150 may derive the attitude that the machine element 200 is actually controlled to have at the via-point Pᵥ by the internal division between the interpolated attitude and the optimum attitude. It should be noted that an internal division between the interpolated attitude and the optimum attitude can be executed, for example, based on a continuous function in which the ratio of the interpolated attitude is 100% at the starting point Pₛ and the end point Pₑ. Due to this, the attitude deriving section 150 can more appropriately derive the attitude of the machine element 200 at the via-point Pᵥ.

The control section 160 controls the drive of the drive unit 220 on the basis of the trajectory generated by the trajectory generating section 120. Specifically, first, the control section 160 grasps the position and the attitude of the machine element 200 from the own machine state of the robot device 10 recognized by the recognizing section 110. Next, the control section 160 controls the drive of the drive unit 220 of the machine element 200 such that the difference between the position and the attitude of the machine element 200 and the position and the attitude of the trajectory generated by the trajectory generating section 120 is reduced. According to this, the control device 100 can operate the machine element 200 from the starting point Pₛ to the end point Pₑ on the basis of the trajectory generated by the trajectory generating section 120.

The drive unit 220 drives each unit of the machine element 200 of the robot device 10 on the basis of the control from the control section 160. For example, the drive unit 220 may be an actuator or the like that drives the joints of the machine element 200.

### <3. Operation Example of Control Device>

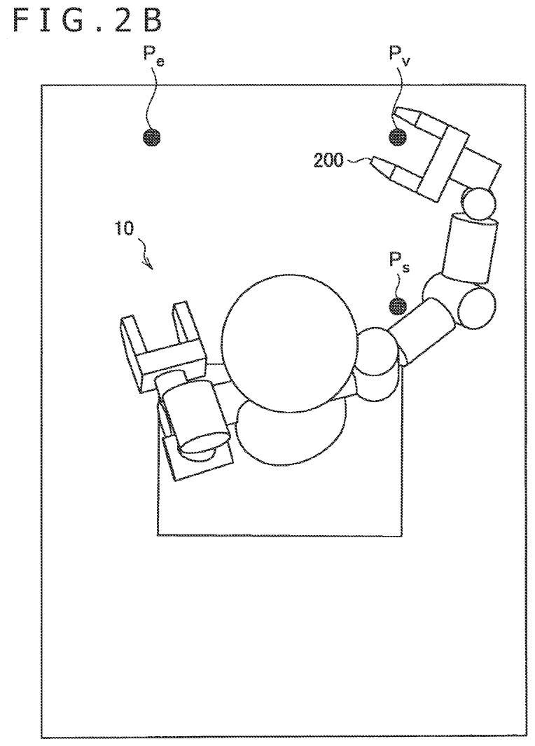

Next, an operation example of the control device 100 at the time of deriving the attitude of the machine element 200 will be described with reference to FIGS. 4 to 10C. FIG. 4 is a flowchart illustrating an operation example of the control device 100 at the time of deriving the attitude of the machine element 200.

First, the control device 100 calculates an Euclidean distance dₛ between the starting point Pₛ and the via-point Pᵥ and the Euclidean distance dv between the via-point Pᵥ and the end point Pₑ (S100). Next, the interpolated attitude deriving section 130 derives the interpolated attitude by performing spherical linear correction on the quaternions representing the attitudes of the machine element 200 (S110).

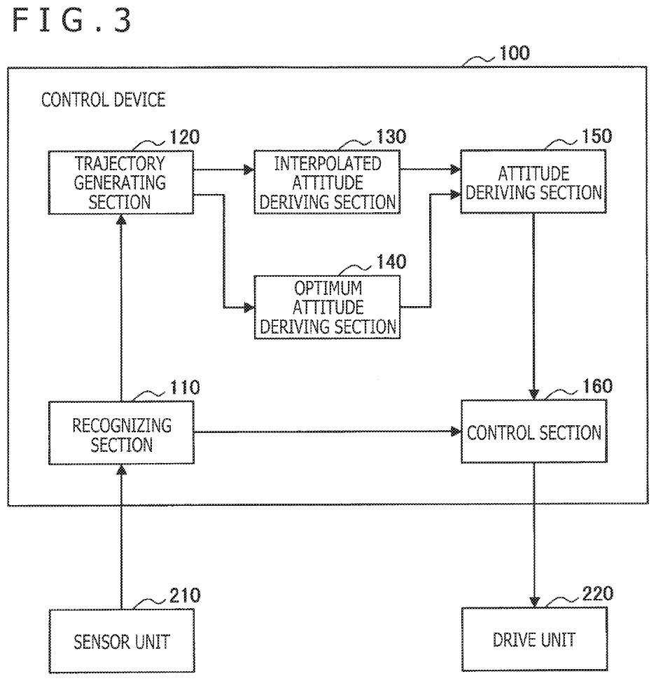

Spherical linear interpolation is a method of interpolation using two independent quaternions q_{A} and q_{B}, and can be performed by the following equation 1 using the parameter t (where 0≤t≤1). As a result, as illustrated in FIG. 5, the interpolated quaternion q(t) can be derived from the quaternions q_{A} and q_{B}.

$$\begin{matrix}[ Math . 1 ] & \\ q ( t ) = \frac{sin ( 1 - l ) θ}{sin θ} {q}_{A} + \frac{sin t θ}{sin θ} {q}_{B} & Equation 1\end{matrix}$$

(where θ=cos⁻¹ (q_{A}·q_{B}))

Note that as for the quaternion, the conjugate quaternion represents the same attitude. Therefore, in Equation 1, in the case where the absolute value of θ exceeds π/2, it is sufficient if either q_{A} or q_{B} is replaced with a conjugate quaternion having a reversed sign for the calculation.

Further, in the case where the attitude of the machine element 200 is represented by Euler angles instead of quaternions, the interpolated attitude deriving section 130 can derive the interpolated attitude by performing linear interpolation for respective components of the roll angle φ, pitch angle θ and yaw angle Ψ of Euler angles. For example, linear interpolation of the roll angle φ can be performed by the following equation 2 using the parameter t (where 0≤t≤1). Incidentally, linear interpolation can be performed for the pitch angle θ and the yaw angle Ψ in a similar manner.

[Math. 2]

φ(t)=(1−t)φ_{A}+tφ_{B} Equation 2

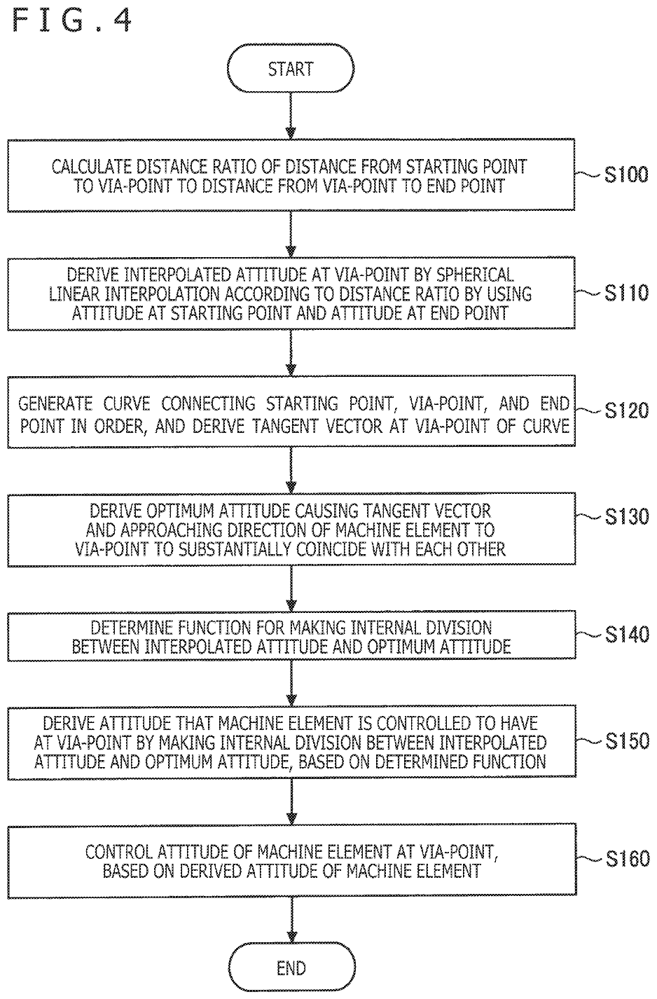

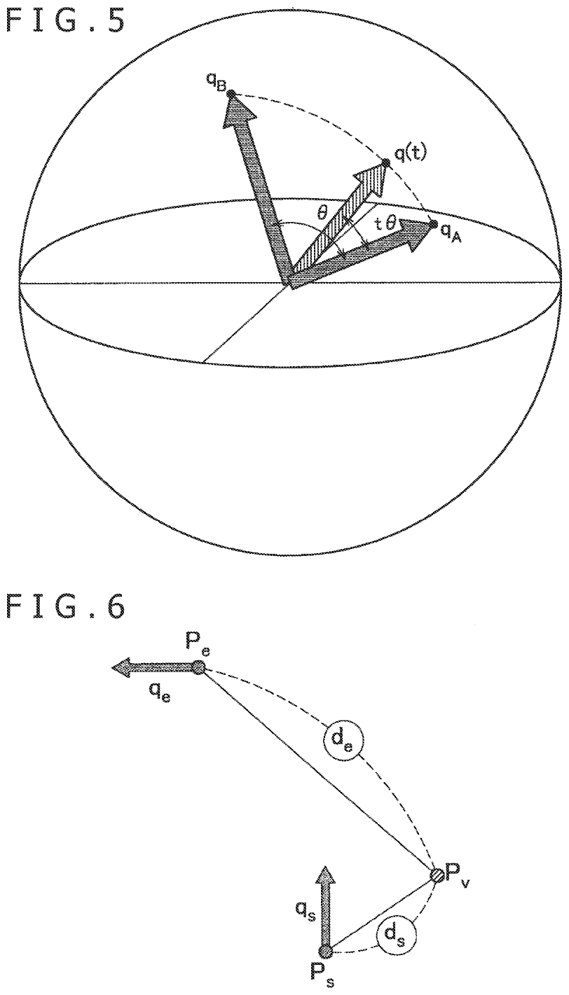

In such a way, the interpolated attitude deriving section 130 can derive the interpolated attitude of the machine element 200 at the via-point Pᵥ as illustrated in FIGS. 6 and 7 by using the spherical linear correction of the quaternion. Specifically, first, as illustrated in FIG. 6, the interpolated attitude deriving section 130 calculates the Euclidean distance dₛ between the starting point Pₛ and the via-point Pᵥ, and the Euclidean distance dᵥ between the via-point Pᵥ and the end point Pₑ. Next, as illustrated in equation 3 below, the parameter tᵢ of the spherical linear correction is determined by calculating the ratio between the calculated Euclidean distances dₛ and dᵥ. As a result, as illustrated in FIG. 7, the interpolated attitude deriving section 130 can derive the interpolated attitude of the machine element 200 at the via-point Pᵥ by the following equation 4.

$$\begin{matrix}[ Math . 3 ] & \\ {t}_{l} = \frac{{d}_{s}}{{d}_{s} + {d}_{s}} & Equation 3 \\ {q}_{l} = \frac{sin ( 1 - {t}_{l} ) θ}{sin θ} {q}_{s} + \frac{sin {t}_{l} θ}{sin θ} {q}_{s} & Equation 4\end{matrix}$$

Next, the optimum attitude deriving section 140 derives a curve that smoothly connects the starting point Pₛ, via-point Pᵥ, and end point Pₑ, and derives the tangent vector L at the via-point Pᵥ of the curve (S120). As a curve that smoothly connects the starting point Pₛ, via-point Pᵥ, and end point Pₑ, a Bezier curve, a spline curve, a B-spline curve, or a curve by Lagrange interpolation can be exemplified, for example.

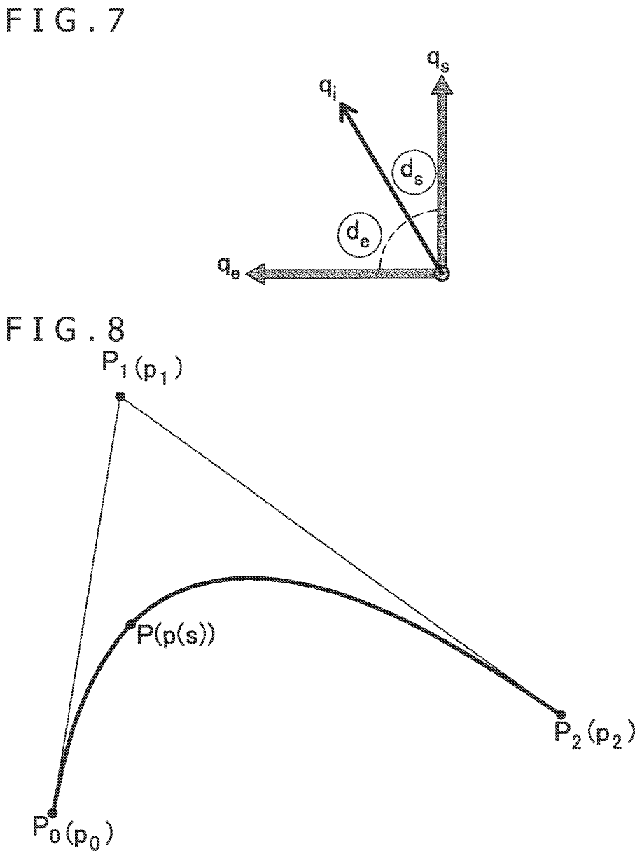

As illustrated in FIG. 8, a quadratic Bezier curve, which is an example of the Bezier curve, is a curve defined by three control points P₀, P₁, and P₂. The point P on the quadratic Bezier curve can be represented by the following equation 5 by using the positions of the three control points P₀, P₁, and P₂ and the parameter s (where 0≤s≤1).

[Math. 4]

p(s)=(1−s)²p₀+2s(1−s)p₁+s²p₂ Equation 5

Therefore, the optimum attitude deriving section 140 can derive the curve smoothly connecting the starting point Pₛ, via-point Pᵥ, and end point Pₑ by appropriately controlling P₁ with P₀ as the starting point Pₛ and P₂ as the end point Pₑ. For example, it is sufficient if P₁ is determined such that the resultant point becomes the via-point Pᵥ when the ratio s₀ of the Euclidean distance dₛ between the starting point Pₛ and the via-point Pᵥ to the Euclidean distance dᵥ between the via-point Pᵥ and the end point Pₑ is substituted for the parameter s. As a result, the tangent vector L at the via-point Pᵥ finally derived is as expressed in equation 6 below.

$$\begin{matrix}[ Math . 5 ] & \\ L = \frac{dp}{ds} ( {s}_{0} ) = - \frac{1 - {s}_{0}}{{s}_{0}} {p}_{s} + \frac{1 - 2 {s}_{0}}{{s}_{0} ( 1 - {s}_{0} )} {p}_{v} + \frac{{s}_{0}}{1 - {s}_{0}} {p}_{s} & Equation 6\end{matrix}$$

Next, the optimum attitude deriving section 140 derives the optimum attitude of the machine element 200 such that the tangent vector L at the via-point Pᵥ of the curve and the approaching direction of the machine element 200 to the via-point Pᵥ substantially coincide with each other (S130).

However, in this method, the attitude of the machine element 200 in the axial direction of the approaching direction to the via-point Pᵥ is not determined. The attitude of the machine element 200 in the axial direction can be derived by linear interpolation between the attitudes of the machine element 200 at the starting point Pₛ and the end point Pₑ, similarly to the interpolated attitude deriving section 130.

It should be noted that as an example of the above modification, the optimum attitude deriving section 140 can also use a bisector direction vector of a straight line vector passing through the starting point Pₛ and the via-point Pᵥ and a straight line vector passing through the via-point Pᵥ and the end point Pₑ, instead of the tangent vector L at the via-point Pᵥ of the curve. In such a case, the optimum attitude deriving section 140 can derive the optimum attitude of the machine element 200 such that the bisector direction vector and the approaching direction of the machine element 200 to the via-point Pᵥ substantially coincide with each other. The bisector direction L₂ can be expressed by the following equation 7, for example.

$$\begin{matrix}[ Math . 6 ] & \\ {L}_{2} = \frac{\vec{{P}_{z} {P}_{v}}}{‖ {P}_{z} {P}_{v} ‖} + \frac{\vec{{P}_{v} {P}_{c}}}{‖ {P}_{v} {P}_{c} ‖} & Equation 7\end{matrix}$$

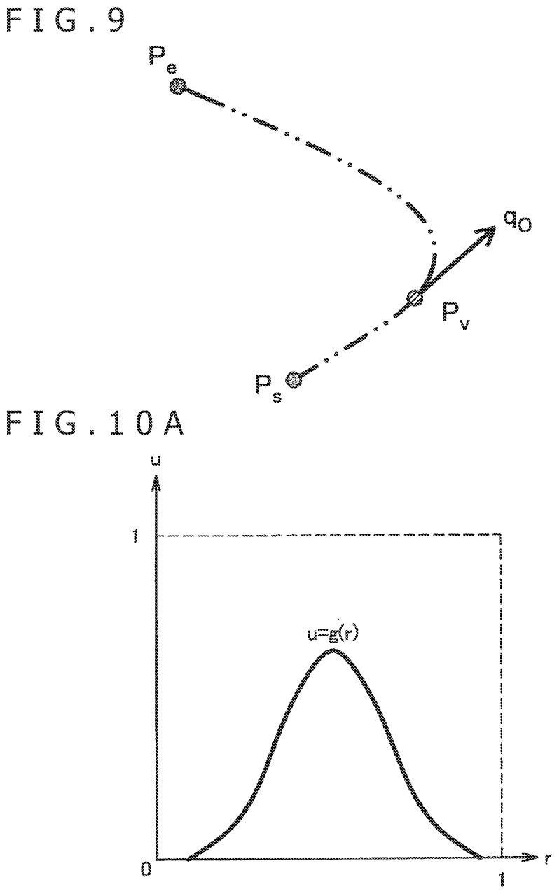

Further, as illustrated in FIG. 9, the optimum attitude deriving section 140 may derive the optimum attitude qₒ by considering the mechanism of the machine element 200. For example, the optimum attitude deriving section 140 may prepare in advance a look-up table in which the optimum attitude has been derived for each of the positions that the machine element 200 can take. The optimum attitude stored in the lookup table may be, for example, the attitude of the machine element 200 that maximizes the manipulability, the attitude of the machine element 200 that minimizes the sum of torque squares applied to each joint of the machine element 200, or a predetermined attitude of the machine element 200 corresponding to a specific task.

Subsequently, the attitude deriving section 150 determines a function for making an internal division between the interpolated attitude and the optimum attitude (S140). After that, the attitude deriving section 150 derives the attitude that the machine element 200 is actually controlled to have at the via-point Pᵥ by making an internal division between the interpolated attitude and the optimum attitude on the basis of the determined function f(pᵥ) (S150).

For example, the attitude qᵥ that the machine element 200 is actually controlled to have at the via-point Pᵥ may be derived on the basis of the following equation 8 by internal division between the interpolated attitude qᵢ and the optimum attitude qₒ with a ratio of u:1−u (where 0≤u≤1) based on the above-mentioned function. Incidentally, the attitude qᵥ, interpolated attitude qᵢ, and optimum attitude qₒ are quaternions, respectively.

$$\begin{matrix}[ Math . 7 ] & \\ {q}_{v} = \frac{sin ( 1 - u ) θ}{sin θ} {q}_{l} + \frac{sin u θ}{sin θ} {q}_{o} & Equation 8\end{matrix}$$

Here, in the case where the via-point Pᵥ coincides with the starting point Pₛ or the end point Pₑ, the attitude qv that the machine element 200 is actually controlled to have is the interpolated attitude qᵢ (namely, the attitude of the machine element 200 at the starting point Pₛ or the end point Pₑ), and therefore the internal division ratio u is desirably controlled to be 0. In addition, considering the continuity of the attitude of the machine element 200, the internal division ratio u desirably changes continuously. Therefore, the internal division ratio u between the interpolated attitude and the optimum attitude are functions f(pᵥ) at the position pᵥ of the via-point Pᵥ, and may be determined to satisfy the following conditions (1) to (3). Note that pₛ represents the position of the starting point Pₛ, and pₑ represents the position of the end point Pₑ.

0≤f(pᵥ)≤1 (1)

f(pₛ)=f(pₑ)=0 (2)

f(pᵥ) is continuous in the domain of pᵥ (3)

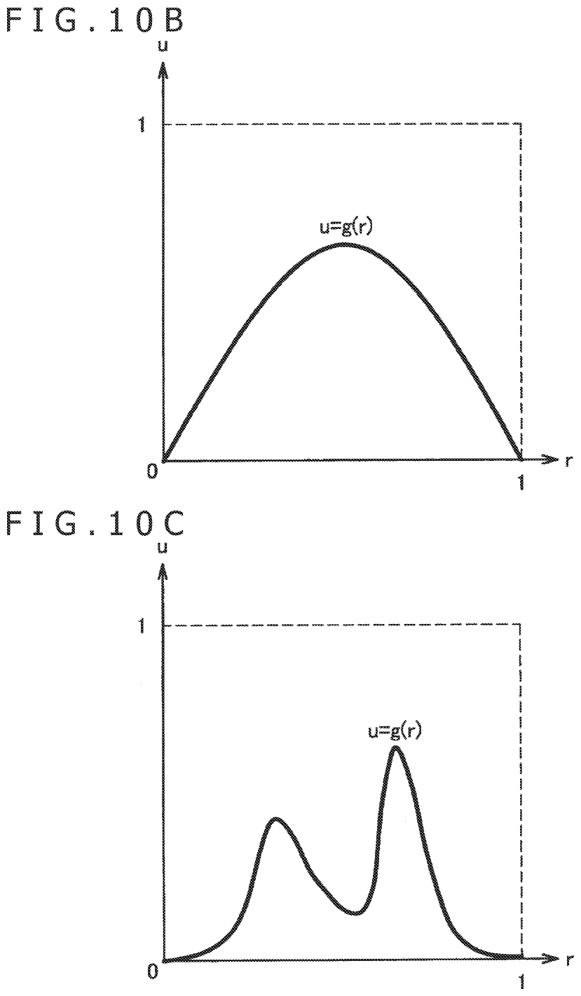

For example, in the case where the ratio r of the Euclidean distance dₛ between the starting point Pₛ and the via-point Pᵥ to the Euclidean distance dv between the via-point Pᵥ and the end point Pₑ is defined by the following equation 9, the function f(pᵥ) controlling u may be functions g(r) illustrated in the graphs in FIGS. 10A to 10C. The function g(r) whose graph is illustrated in FIG. 10A is a B-spline basis function, the function g(r) whose graph is illustrated in FIG. 10B is a quadratic function drawing a parabolic line, and the function g(r) whose graph is illustrated in FIG. 10C is an optional function that satisfies the above conditions (1) to (3).

$$\begin{matrix}[ Math . 8 ] & \\ r ( {p}_{v} ) = \frac{{d}_{s}}{{d}_{z} + {d}_{c}} & Equation 9\end{matrix}$$

According to the above operation, the interpolated attitude deriving section 130, optimum attitude deriving section 140, and attitude deriving section 150 can derive an appropriate attitude of the machine element 200 at the via-point Pᵥ. As a result, the control device 100 can control the attitude of the machine element 200 at the via-point Pᵥ on the basis of the derived attitude (S160).

It should be noted that the attitude derivation method described above is merely an example, and the technique according to the present disclosure is not limited to the attitude derivation method described above.

For example, the optimum attitude deriving section 140 may derive an optimum attitude obtained by weighting and adding to each other a plurality of optimum attitudes derived from each of a plurality of viewpoints as the optimum attitude to be used by the attitude deriving section 150. Further, the attitude deriving section 150 may dynamically control the internal division ratio between the interpolated attitude and the optimum attitude on the basis of the environmental information around the robot device 10 (for example, obstacle information) or the information regarding the manipulability or the singularity of the machine element 200. In addition, in the case where there is a constraint condition for the attitude that the machine element 200 can take, the optimum attitude deriving section 140 may control the optimum attitude so as to satisfy the constraint condition, and the attitude deriving section 150 may control the internal division ratio between the interpolated attitude and the optimum attitude so as to satisfy the constraint condition.

### <4. Hardware Configuration Example>

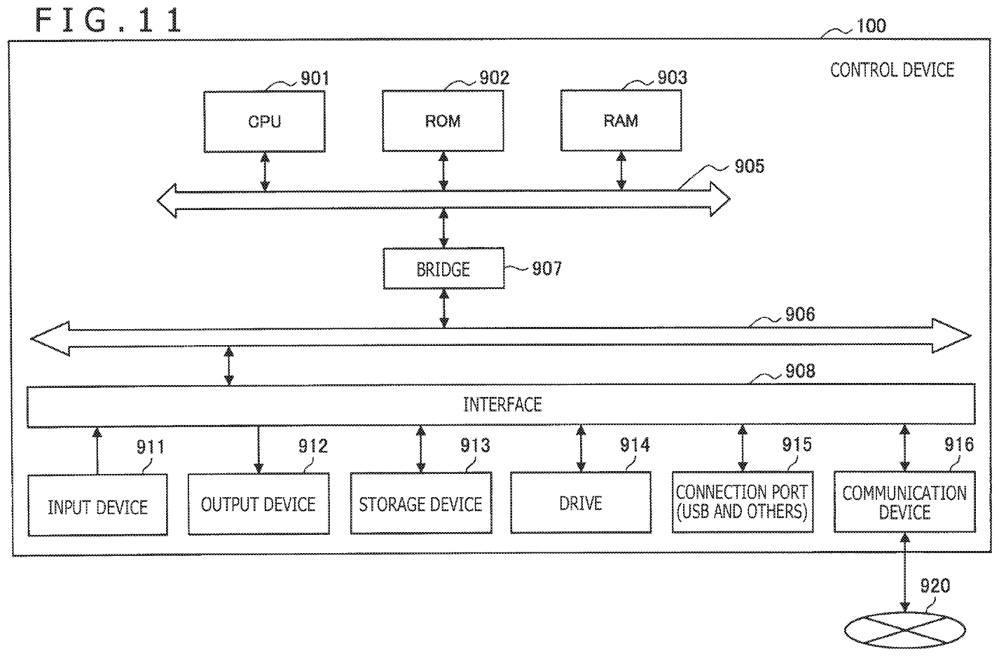

Next, an example of the hardware configuration of the control device 100 according to the present embodiment will be described with reference to FIG. 11. FIG. 11 is a block diagram illustrating an example of the hardware configuration of the control device 100 according to the present embodiment.

As illustrated in FIG. 11, the control device 100 includes a CPU (Central Processing Unit) 901, a ROM (Read Only Memory) 902, a RAM (Random Access Memory) 903, a host bus 905, a bridge 907, an external bus 906, an interface 908, an input device 911, an output device 912, a storage device 913, a drive 914, a connection port 915, and a communication device 916. The control device 100 may include a processing circuit such as an electric circuit, a DSP, or an ASIC in place of or in combination with the CPU 901.

The CPU 901 functions as an arithmetic processing unit and a control device, and controls the overall operation in the control device 100 in accordance with various programs. Further, the CPU 901 may be a microprocessor. The ROM 902 stores programs, calculation parameters, and the like to be used by the CPU 901. The RAM 903 temporarily stores a program to be used for the execution of the CPU 901, parameters that change appropriately in the execution, and the like. The CPU 901 may execute the functions of the recognizing section 110, trajectory generating section 120, interpolated attitude deriving section 130, optimum attitude deriving section 140, attitude deriving section 150, and control section 160, for example.

The CPU 901, ROM 902, and RAM 903 are connected to each other by a host bus 905 including a CPU bus and the like. The host bus 905 is connected to an external bus 906 such as a PCI (Peripheral Component Interconnect/Interface) bus via a bridge 907. Incidentally, the host bus 905, bridge 907, and external bus 906 do not necessarily have to be separately configured, and these functions may be implemented in one bus.

The input device 911 is a device in which information is input by a user, such as a mouse, a keyboard, a touch panel, a button, a microphone, a switch, or a lever. Alternatively, the input device 911 may be a remote control device using infrared rays or other radio waves, or may be an externally connected device such as a mobile phone or a PDA that supports the operation of the control device 100. Further, the input device 911 may include, for example, an input control circuit that generates input signals on the basis of the information input by the user, using the above input means.

The output device 912 is a device capable of visually or audibly notifying the user of information. The output device 912 may be, for example, a display device such as a CRT (Cathode Ray Tube) display device, a liquid crystal display device, a plasma display device, an EL (ElectroLuminence) display device, a laser projector, an LED (Light Emitting Diode) projector, or a lamp, and may be an audio output device such as a speaker or headphones.

The output device 912 may output, for example, the results obtained by various processes by the control device 100. Specifically, the output device 912 may visually display the results obtained by various processes by the control device 100 in various formats such as texts, images, tables, or graphs. Alternatively, the output device 912 may convert an audio signal such as voice data or acoustic data into an analog signal and output the signal audibly.

The storage device 913 is a device for data storage formed as an example of the storage unit of the control device 100. The storage device 913 may be achieved by, for example, a magnetic storage device such as an HDD (Hard Disk Drive), a semiconductor storage device, an optical storage device, or an optical magnetic storage device. For example, the storage device 913 may include a storage medium, a recording device that records data in the storage medium, a reading device that reads data from the storage medium, a deletion device that deletes the data recorded in the storage medium, and the like. The storage device 913 may store a program and various data executed by the CPU 901, various data acquired from the outside, and the like.

The drive 914 is a reader/writer for a storage medium, and is built in or externally attached to the control device 100. The drive 914 reads information recorded in a magnetic disk, an optical disk, a magneto-optical disk, which are mounted or a removable storage medium such as a semiconductor memory, and outputs the information to the RAM 903. Alternatively, the drive 914 can also write information in the removable storage medium.

The connection port 915 is an interface connected to an external device. The connection port 915 is a connecting port capable of exchanging data with an external device, and may be a USB (Universal Serial Bus), for example.

The communication device 916 is, for example, an interface formed by a communication device or the like for connecting to the network 920. The communication device 916 may be a communication card for a wired or wireless LAN (Local Area Network), an LTE (Long Term Evolution), a Bluetooth (registered trademark), or a WUSB (Wireless USB), for example. Further, the communication device 916 may be a router for optical communication, a router for an ADSL (Asymmetric Digital Subscriber Line), a modem for various communications, or the like. The communication device 916 can transmit and receive signals and the like to and from the Internet or other communication devices in accordance with a predetermined protocol such as TCP/IP.

Note that the network 920 is a wired or wireless transmission line for information. For example, the network 920 may include a public network such as the Internet, a telephone line network or a satellite communication network, various LANs (Local Area Network) including Ethernet (registered trademark), a WAN (Wide Area Network), and the like. Further, the network 920 may include a dedicated line network such as an IP-VPN (Internet Protocol-Virtual Private Network).

Note that a computer program for hardware such as a CPU, a ROM, and a RAM built in the control device 100 to exert functions equivalent to those of each configuration of the control device according to the above-described embodiment can also be generated. Further, a storage medium in which the computer program is stored can also be provided.

### <5. Summary>

The control device 100 according to the present embodiment described above can derive the attitude of the machine element 200 at the via-point Pᵥ by not only simple interpolation based on the attitudes of the machine element 200 at the starting point Pₛ and at the end point Pₑ but also in consideration of the optimum attitude of the machine element 200 at the via-point Pᵥ.

According to this, the control device 100 can make the attitude of the machine element 200 at the via-point Pᵥ more appropriate, so that the reachable range of the machine element 200 can be expanded.

Further, the control device 100 can control the attitude of the machine element 200 at the via-point Pᵥ according to a requirement or a constraint condition by setting the optimum attitude so as to satisfy the requirement or the constraint condition for the machine element 200.

Further, since the control device 100 can derive the attitude of the machine element 200 at the via-point Pᵥ from the position, in the case where the trajectory is generated by teaching, it is sufficient if only the position of the machine element 200 is taught without the teaching of the attitude of the machine element 200. According to this, the control device 100 can improve the efficiency of teaching.

In addition, the control device 100 can reduce the number of dimensions of the search space from the 6-dimensional space of the position and the attitude of the machine element 200 to the 3-dimensional space of only the position of the machine element 200 when searching for the trajectory, which can make searching more efficient.

Hereinabove, although the preferred embodiments of the present disclosure have been described in detail with reference to the accompanying drawings, the technical scope of the present disclosure is not limited to such examples. It is clear that anyone with ordinary knowledge in the technical field of the present disclosure may come up with various alterations or modifications within the scope of the technical ideas set forth in the claims, and thus it is understood that the alterations and modifications belong to the technical scope of the present disclosure as a matter of course.

In addition, the effects described herein are merely explanatory or exemplary and are not limitative. That is, the techniques according to the present disclosure may exhibit other effects apparent to those skilled in the art from the description herein, in addition to or in place of the above effects.

It is to be noted that the following configurations also belong to the technical scope of the present disclosure.

(1)

A control device including:
an interpolated attitude deriving section that derives an interpolated attitude at a via-point of a machine element moving in a trajectory that reaches an end point via the via-point from the starting point;
an optimum attitude deriving section that derives an optimum attitude of the machine element at the via-point; and
an attitude deriving section that derives an attitude that the machine element is controlled to have at the via-point, based on the interpolated attitude and the optimum attitude.
   (2)

The control device according to the above-mentioned (1), in which
the interpolated attitude deriving section derives the interpolated attitude, based on an attitude of the machine element at the starting point and an attitude of the machine element at the end point.
   (3)

The control device according to the above-mentioned (2), in which
the interpolated attitude deriving section derives the interpolated attitude by linear interpolation between the attitude of the machine element at the starting point and the attitude of the machine element at the end point.
   (4)

The control device according to the above-mentioned (3), in which
the linear interpolation is performed, based on a ratio of a distance from the starting point to the via-point to a distance from the end point to the via-point.
   (5)

The control device described according to any one of the above-mentioned (1) to (4), in which
the optimum attitude deriving section derives the optimum attitude, based on a mechanistic feature of the machine element.
   (6)

The control device according to the above-mentioned (5), in which
the optimum attitude deriving section derives the optimum attitude, based on at least any one or more of a manipulability of the machine element, a torque applied to the machine element, or a singularity of the machine element.
   (7)

The control device according to the above-mentioned (5), in which
the optimum attitude deriving section derives the optimum attitude that causes a tangential vector of a continuous curve passing through the starting point, the via-point, and the end point in order and an approaching direction of the machine element to the via-point to substantially coincide with each other.
   (8)

The control device according to the above-mentioned (7), in which
the curve is either a Bezier curve, a spline curve, a B-spline curve, or a curve by Lagrange interpolation.
   (9)

The control device according to any one of the above-mentioned (5) to (8), in which
the optimum attitude deriving section derives the optimum attitude by weighting and superimposing a plurality of attitudes.
   (10)

The control device according to any one of the above-mentioned (1) to (9), in which
the attitude deriving section derives an attitude that the machine element is controlled to have at the via-point by an internal division between the interpolated attitude and the optimum attitude.
   (11)

The control device according to the above-mentioned (10), in which
a ratio of the internal division is determined, based on a function based on a ratio of a distance from the starting point to the via-point to a distance from the end point to the via-point.
   (12)

The control device according to (11), in which
the function is a continuous function.
   (13)

The control device according to the above-mentioned (11) or (12), in which
the function is a function in which the attitude that the machine element is controlled to have at the via-point is taken as the interpolated attitude in a case where the via-point coincides with the starting point or the end point.
   (14)

The control device according to any one of the above-mentioned (11) to (13), in which
the function is changed, based on environmental information or own machine information of the machine element.
   (15)

A control method performed by a calculation device, the control method including:
deriving an interpolated attitude at a via-point of a machine element moving in a trajectory that reaches an end point via the via-point from a starting point;
deriving an optimum attitude of the machine element at the via-point; and
deriving an attitude that the machine element is controlled to have at the via-point, based on the interpolated attitude and the optimum attitude.
   (16)

A program that causes a computer to function as:
an interpolated attitude deriving section that derives an interpolated attitude at a via-point of a machine element moving in a trajectory that reaches an end point via the via-point from a starting point;
an optimum attitude deriving section for deriving an optimum attitude of the machine element at the via-point; and
an attitude deriving section that derives an attitude that the machine element is controlled to have at the via-point, based on the interpolated attitude and the optimum attitude.

### REFERENCE SIGNS LIST

10: Robot device

100: Control device

110: Recognizing section

120: Trajectory generating section

130: Interpolated attitude deriving section

140: Optimum attitude deriving section

150: Attitude deriving section

160: Control section

200: Machine element

210: Sensor unit

220: Drive unit

1. A control device comprising:
an interpolated attitude deriving section that derives an interpolated attitude at a via-point of a machine element moving in a trajectory that reaches an end point via the via-point from a starting point;
an optimum attitude deriving section that derives an optimum attitude of the machine element at the via-point; and
an attitude deriving section that derives an attitude that the machine element is controlled to have at the via-point, based on the interpolated attitude and the optimum attitude.

2. The control device according to claim 1, wherein
the interpolated attitude deriving section derives the interpolated attitude, based on an attitude of the machine element at the starting point and an attitude of the machine element at the end point.

3. The control device according to claim 2, wherein
the interpolated attitude deriving section derives the interpolated attitude by linear interpolation between the attitude of the machine element at the starting point and the attitude of the machine element at the end point.

4. The control device according to claim 3, wherein
the linear interpolation is performed, based on a ratio of a distance from the starting point to the via-point to a distance from the end point to the via-point.

5. The control device according to claim 1, wherein
the optimum attitude deriving section derives the optimum attitude, based on a mechanistic feature of the machine element.

6. The control device according to claim 5, wherein
the optimum attitude deriving section derives the optimum attitude, based on at least any one or more of a manipulability of the machine element, a torque applied to the machine element, or a singularity of the machine element.

7. The control device according to claim 5, wherein
the optimum attitude deriving section derives the optimum attitude that causes a tangential vector of a continuous curve passing through the starting point, the via-point, and the end point in order and an approaching direction of the machine element to the via-point to substantially coincide with each other.

8. The control device according to claim 7, wherein
the curve is either a Bezier curve, a spline curve, a B-spline curve, or a curve by Lagrange interpolation.

9. The control device according to claim 5, wherein
the optimum attitude deriving section derives the optimum attitude by weighting and superimposing a plurality of attitudes.

10. The control device according to claim 1, wherein
the attitude deriving section derives an attitude that the machine element is controlled to have at the via-point by an internal division between the interpolated attitude and the optimum attitude.

11. The control device according to claim 10, wherein
a ratio of the internal division is determined, based on a function based on a ratio of a distance from the starting point to the via-point to a distance from the end point to the via-point.

12. The control device according to claim 11, wherein
the function is a continuous function.

13. The control device according to claim 11, wherein
the function is a function in which the attitude that the machine element is controlled to have at the via-point is taken as the interpolated attitude in a case where the via-point coincides with the starting point or the end point.

14. The control device according to claim 11, wherein
the function is changed, based on environmental information or own machine information of the machine element.

15. A control method performed by a calculation device, the control method comprising:
deriving an interpolated attitude at a via-point of a machine element moving in a trajectory that reaches an end point via the via-point from a starting point;
deriving an optimum attitude of the machine element at the via-point; and
deriving an attitude that the machine element is controlled to have at the via-point, based on the interpolated attitude and the optimum attitude.

16. A program that causes a computer to function as:
an interpolated attitude deriving section that derives an interpolated attitude at a via-point of a machine element moving in a trajectory that reaches an end point via the via-point from a starting point;
an optimum attitude deriving section for deriving an optimum attitude of the machine element at the via-point; and
an attitude deriving section that derives an attitude that the machine element is controlled to have at the via-point, based on the interpolated attitude and the optimum attitude.
